(19) United States
(12) Patent Application Publication
(10) Pub. No.: US 2005/0196049 A1
(43) Pub. Date: Sep. 8, 2005

(54) System and method for encoding live audio/video information

(76) Inventor: Adam Leslie Clark, Melbourne (AU)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/770,952

(22) Filed: Feb. 2, 2004

(51) Int. Cl. G06K 9/36

(52) U.S. Cl. 382/232

(57) ABSTRACT

A method and apparatus for encoding a frame of audio/video data, segment by segment, comprising a number of pixels each having a plurality of pixel color components by creating a frame group table in which each pixel entry includes a dominant pixel color component of the plurality of pixel color components, and determining a set of segment reference pixels for each encoded segment, wherein each one of the segment reference pixels is a pixel within each one of the encoded segments having a most intense dominant pixel color value.

### FIELD OF THE INVENTION

The present invention relates generally to communication systems and, in particular, to a system and method for compressing live video for transmission over low bandwidth communication links.

### BACKGROUND OF THE INVENTION

Video signals can be digitized, encoded, and subsequently decoded in a manner which significantly decreases the number of bits necessary to represent a decoded reconstructed video without noticeable, or with acceptable, degradation in the reconstructed video. Video coding is an important part of many applications such as digital television transmission, video conferencing, video databases, etc.

In video conferencing applications, for example, a video camera is typically used to capture a series of images of a target, such as a meeting participant or a document. The series of images is encoded as a data stream and transmitted over a communications channel to a remote location. For example, the data stream may be transmitted over a phone line, satellite, an integrated services digital network (ISDN) line, or the Internet.

In general, connection of a user interface device to the Internet may be made by a variety of communication channels, including twisted pair telephone lines, coaxial cable, and wireless signal communication via local transceivers or orbiting satellites. Most user interface device Internet connections are made by relatively low-bandwidth communication channels, mainly twisted pair telephone lines, due to the existing infrastructure of such telephone lines and the cost of implementing high-bandwidth infrastructure. This constrains the type of information that may be presented to users via the Internet connection, because video transmissions using presently available coding techniques generally require greater bandwidth than twisted pair telephone wires can provide for optional viewing.

The encoding process is typically implemented using a digital video coder/decoder (codec), which divides the images into blocks and compresses the blocks according to a video compression standard, such as the ITU-T H.263 and H.261 standards. In compression schemes of this type, a block may be compressed independent of the previous image or as a difference between the block and part of the previous image. In a typical video conferencing system, the data stream is received at a remote location, where it is decoded into a series of images, which may be viewed at the remote location. Depending on the equipment used, this process typically occurs at a rate of one to thirty frames per second.

One technique widely used in video systems is hybrid video coding. An efficient hybrid video coding system is based on the ITU-T Recommendation H.263. The ITU-T Recommendation H.263 adopts a hybrid scheme of motion-compensated prediction to exploit temporal redundancy and transform coding using the discrete cosine transform (DCT) of the remaining signal to reduce spatial redundancy. Half pixel precision is used for the motion compensation, and variable length coding is used for the symbol representation.

However these techniques still do not provide adequate results for the low-bandwidth connections such as dial-up connections or wireless device networks (e.g., GSM or CDMA) that have data transmission rates as low as 9.6 kilobits/sec, 14.4 kilobits/sec, 28.8 kilobits/sec or 56 kilobits/sec. For users at the end of a dial-up connection or wireless network, high quality video takes extraordinary amounts of time to download. Streaming high quality video is nearly impossible, and providing live video feeds is generally unfeasible.

### SUMMARY OF THE INVENTION

A method and apparatus, according to one embodiment of the present invention, are utilized and configured to encode a live or streamed video stream by encoding frames of audio/video data, segment by segment, each frame including a number of pixels and each pixel having a plurality of pixel color components. The encoding process includes creating a frame group table of encoded pixel values in which each pixel entry includes a dominant pixel color component of the plurality of pixel color components. For each encoded segment of the frame, the encoder determines a set of segment reference pixels, wherein each segment reference pixel is a pixel within the segment having a most intense dominant pixel color.

In one embodiment of the present invention, prior to encoding the pixel data, the encoder creates a frame group file to store a header, the frame table and segment reference pixels. In various embodiments, the encoder may also store any associated audio/video data, synchronization information, or tags into the frame group file or may create one or more separate files for such information. The plurality of pixel color components stored within the table may include any or all of luminance, chrominance, and color depth information. Prior to entry within the frame group table, the encoder scales down each entry to reduce the amount of stored data. In another embodiment, the non-dominant color values are also scaled down and entered into the table.

In one embodiment of the present invention, determining the set of segment reference pixels includes comparing, on a pixel by pixel basis for each segment, a current pixel color value with a previously stored dominant pixel color value and storing the plurality of pixel color components and pixel parameters of the pixel with the most intense dominant pixel color component.

In one embodiment of the present invention, the plurality of pixel color components include at least one of the sets of primary color components, red, green, and blue; or cyan, magenta, and yellow and the segment reference pixels include the primary color components and black. Black may be determined by comparing an average or aggregation of the red, green, and blue pixel component values to a black threshold value.

Among various embodiments of the present invention, the encoded segment of a frame may include a line of a frame, a half of a frame, or other fraction of a frame.

In one embodiment of the present invention, the encoder writes a pointer to the next frame group within the frame group file to ensure the decoder decodes the frame groups in the correct sequence.

In one embodiment of the present invention, redundant encoded pixel values of the frame group table share common table entries and therefore share identical dominant pixel color components and identical pixel parameter values. In another embodiment, the redundant encoded pixel values share dominant pixel color components and pixel parameters values that are similar to one another within a tolerance range.

### BRIEF DESCRIPTION OF THE DRAWINGS

The present invention will be understood and appreciated more fully from the following detailed description taken in conjunction with the drawings in which:

FIG. 1 is a block diagram of an exemplary system for compressing streamed or live video, according to one embodiment of the present invention;

FIG. 2 illustrates a sequence of video frames with its corresponding raw video data, according to one embodiment of the invention;

FIG. 3A illustrates the encoding of a raw video table, according to one embodiment of the present invention;

FIG. 3B illustrates a segment reference pixel table, according to one embodiment of the present invention;

FIG. 4 illustrates the decoding of a compressed video file, according to one embodiment of the present invention;

FIG. 5 is a flow diagram showing an example of an encoding process, according to one embodiment of the present invention;

FIG. 6 is a flow diagram illustrating an example of a decoding process, according to one embodiment of the present invention;

FIG. 7 illustrates an exemplary network architecture for use according to one embodiment of the present invention; and

FIG. 8 illustrates an exemplary computer architecture for use according to one embodiment of the present invention.

### DETAILED DESCRIPTION

A system and method for encoding video are described. The present encoding system and method overcome prior deficiencies in streaming live video content by encoding and decoding video data such that high-quality video transmission over low bandwidth communication links is possible. In the following description, for purposes of explanation, numerous specific details are set forth in order to provide a thorough understanding of the present invention. It will be evident, however, to one skilled in the art that the present invention may be practiced without these specific details. In some instances, well-known structures and devices are shown in block diagram form, rather than in detail, in order to avoid obscuring the present invention. These embodiments are described in sufficient detail to enable those skilled in the art to practice the invention, and it is to be understood that other embodiments may be utilized and that logical, mechanical, electrical, and other changes may be made without departing from the scope of the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, signals, datum, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention can be implemented by an apparatus for performing the operations herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and processes presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor or by any combination of hardware and software. One of skill in the art will immediately appreciate that the invention can be practiced with computer system configurations other than those described below, including hand-held devices, multiprocessor systems, microprocessor-based or programmable consumer electronics, DSP devices, network PCs, minicomputers, mainframe computers, and the like. The invention can also be practiced in distributed computing environments where tasks are performed by remote processing devices that are linked through a communications network. The required structure for a variety of these systems will appear from the description below.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, etc.), as taking an action or causing a result. Such expressions are merely a shorthand way of saying that execution of the software by a computer causes the processor of the computer to perform an action or produce a result.

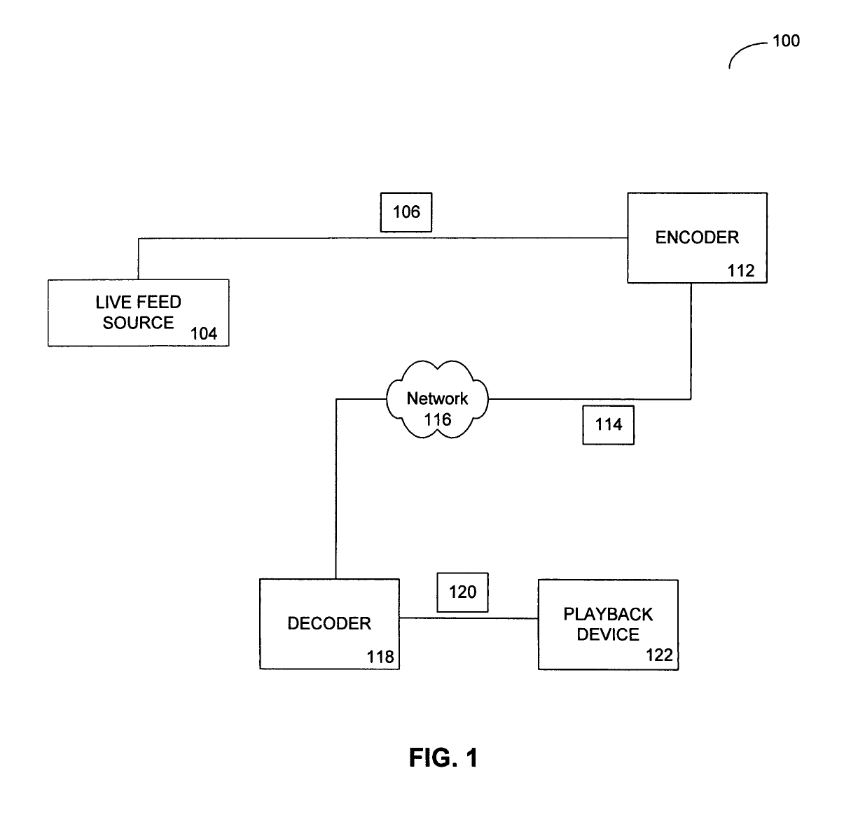

FIG. 1 is a block diagram of an exemplary system 100 for live video compression, according to one embodiment of the present invention. Video compression system 100 is designed to encode and deliver high quantity live video over low bandwidth transmission links (e.g., 9.6-56 kBps). In one embodiment of the present invention, video compression system 100 obtains video from a live feed source 104, such as a camera recording a live sporting event. Among varying embodiments, the source contributing video data to be streamed “live” may also be any device capable of delivering video content, such as a digital versatile disc (DVD), a computer storage device, or digital video tape. It should be noted, analog video storage devices may also be used so long as the video stored thereon is first converted to a digital format prior to “live” encoding.

A live feed source 104 produces digital output video signals in a raw data file format. Generally, audio signals accompany the video signals from source devices such as live feed source 104. The audio signals may be digitized and/or compressed and provided along with the raw video data, either in a separate file or appended to the video file. In one embodiment of the present invention, the audio data may be processed independent of the raw video data 106 according to any audio compression method including the MPEG's (Moving Picture Experts Group) “MP3” or Microsoft's “wav” format. Such audio may be synchronized with the video data file 106 at any point within the compression system 100.

The raw video data 106, including a start stream header, is provided to an encoder 112. The start stream header is included at the start of the stream of raw video data 106 and may include information regarding the audio data and raw video data 106, such as video frame starting and ending points, video tag information, the number of video frames per second, frame resolution (i.e., the number of pixels per frame), color depth information, audio synch information, and similar data regarding the video data stream that may be used by the encoder 112.

Compression system 100 uses the encoder 112 to compress raw video data 106 for streaming video to a decoder at or near real-time. The details of the encoding process performed by encoder 112 will be discussed below. The encoder 112 produces a compressed or encoded video file 114, which may include for each frame group, segment reference pixel values, encoded pixel data for all frames within the frame group, and header information for an encoded frame group, such as resolution settings for the decoder and audio/video synch information. In another embodiment, a trailer within the compressed video file may be generated that may include other audio/video information such as a pointer identifying the next frame group to be decoded. The majority of the compressed video file 114 is a frame group table of pixel parameter values for each pixel of each video frame comprising the acquired video. Encoder 112 may also produce an audio output file that may or may not be compressed, as discussed above. For purposes of this specification, reference to the compressed video file 114 includes any audio/visual data, optional data and/or header and trailer information. It should be appreciated, however, that in other embodiments, the header, the trailer, the compressed video data, and audio data may be written to separate files or appended to one or more files in any combination thereof.

The compressed video file 114 may be transmitted over a network 116 to the decoder 118. The decoder 118 decodes the compressed video file 114 to include a decompressed video file 120 and synchronizes the audio data (if any) for audio/visual viewing via playback device 122. Playback device 122 may be any device accepting video data such as a television, cellular phone display, personal computer, personal digital assistant (PDA), automobile navigation system, or other similar device capable of displaying video data. The process performed by the decoder 118 will be described in detail below.

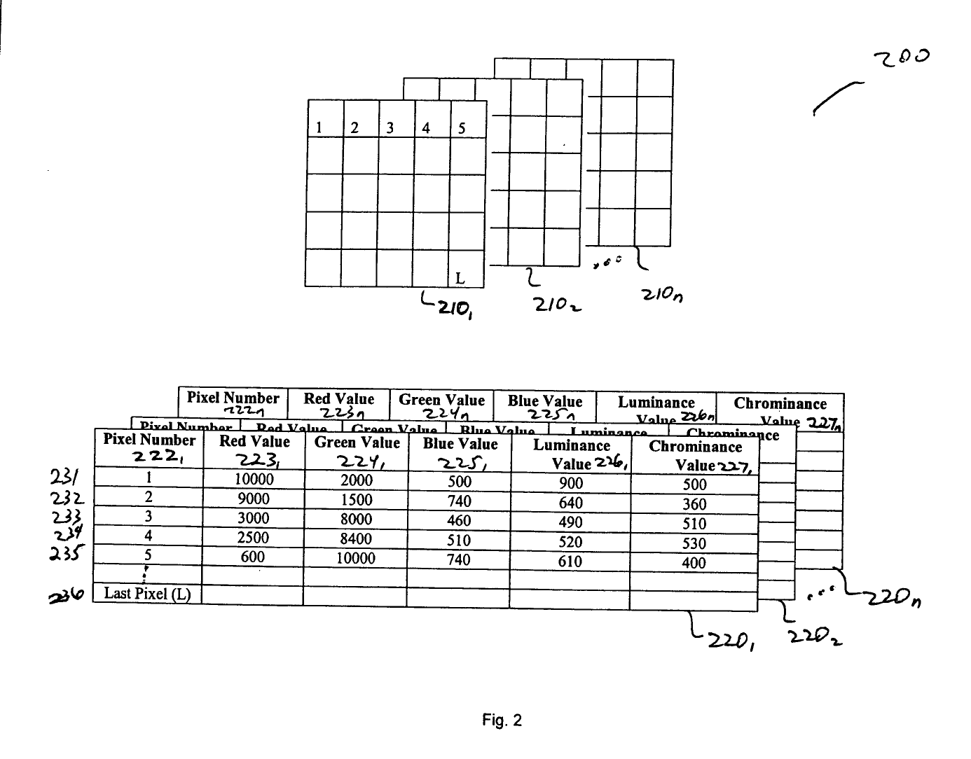

FIG. 2 illustrates a sequence of video frames with its corresponding table of raw video data, according to one embodiment of the present invention. Video sequence 200 is composed of a number of video frames 210₁-210ₙ. Each video frame 210 is composed of thousands of pixels. The exact number of pixels in a frame depends upon the digital video format and more specifically, the frame resolution used. The present method and system support High Definition Digital TV (HDTV), National TV Standards Committee (NTSC) having 30 interlaced frames per second at 525 lines of resolution with an audio FM frequency and a MTS signal for stereo, Phase Alternating Line (PAL) standards having 25 interlaced frames per second at 625 lines of resolution, System en coleur avec memoire (SECAM) and similar protocols. It should be noted, however, any analog audio/video format is to be converted to a digital audio/video format prior to encoding by encoder 112.

Live feed source 104 generates frames 210 and provides the raw video data file 106 that describes video frames 210₁₋ₙ and their corresponding pixels. The raw video data file 106 contains the raw video frame data tables 220₁₋ₙ, where n represents the number of frames, and each row 231-236 corresponds to pixels in each video frame 210, where the pixels between 235 and the last pixel 236 have been omitted for clarity. The columns of each raw video frame data table 220 describe the pixel numbers 222, red color component values 223, green color component values 224, blue color component values 225 (RGB values), luminance values 226, and chrominance values 227 for each pixel in the respective frame 210. In alternate embodiments, other color spaces may be used such as, cyan, magenta, and yellow (CyMgYl).

As illustrated with reference to FIG. 2, each pixel parameter 223-227 of each pixel 222 in each frame table 220 requires multiple bytes of information to be stored per pixel, thus creating large file sizes for multiple frames of video data. Considering high quality video requires at least a frame rate of 25 frames per second or 1,500 frames/minute, it should be apparent that the amount of storage and/or bandwidth required to stream and play an uncompressed or slightly compressed video file is quite large.

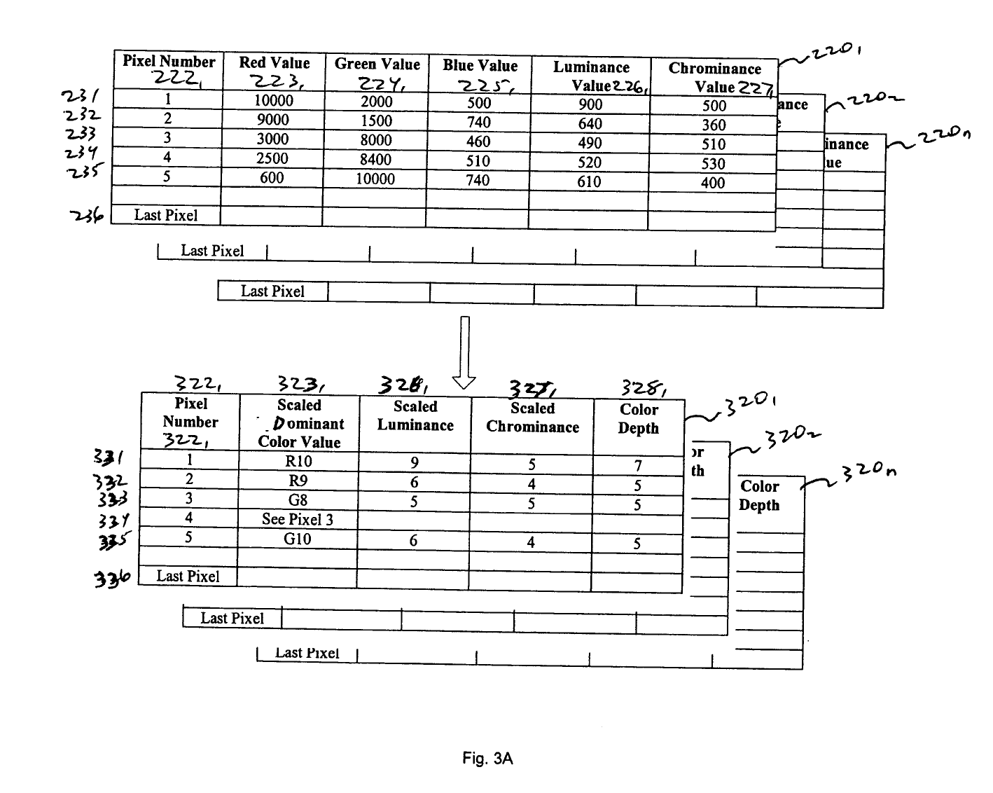

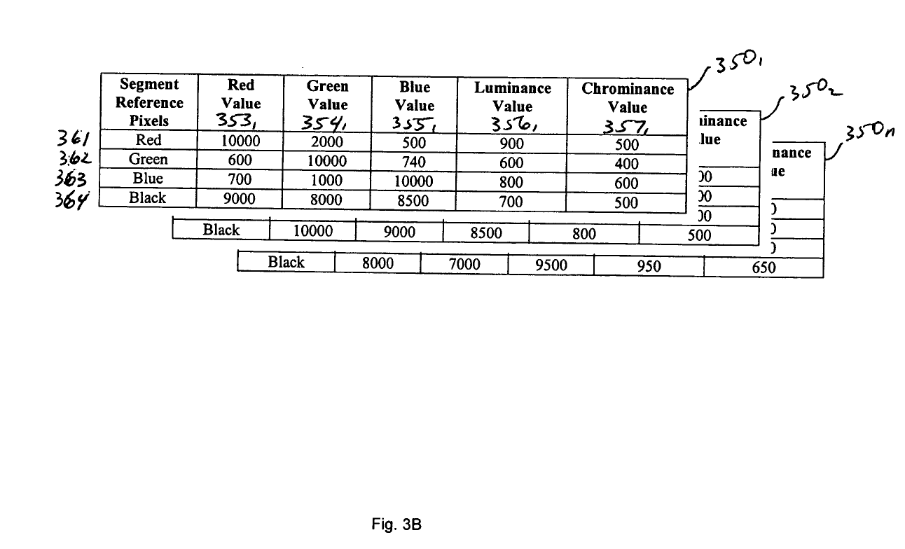

FIG. 3A illustrates a table of raw video data 220₁ encoded into a frame group table 320₁, according to one embodiment of the present invention. The pixel numbers in column 222₁ are mapped to pixel numbers in column 322₁. For each row, 231-236, of raw pixel data in table 220₁ there is a corresponding row, 331-336, of compressed pixel data in table 320₁, where the pixels between 235 (335) and the last pixel 236 (336) have been omitted for clarity. The pixel value sets (i.e., RGB values 223₁-225₁) are processed and mapped to dominant color value 323₁, as illustrated by pixel 1 value R10 in table 320₁. The calculation of the dominant color value 323₁ will be discussed below. The luminance value 226₁ is mapped to a scaled luminance value 326₁ and the chrominance value 227₁ is mapped to a scaled chrominance value 327₁. The calculation of scaled chrominance and luminance values 327₁, 326₁ will also be discussed below. Each compressed video table 320 may further include color depth values 328. In one embodiment, the color depth value 328 is the average of the scaled chrominance and luminance values 327, 326. According to one embodiment, as encoder 120 populates compressed video table 320, if a row of compressed pixel data is determined to be identical or at least sufficiently similar to a previously populated row, encoder 112 places a pointer to the appropriate previously entered row, as illustrated with reference to 334.

FIG. 3B illustrates pixel reference value sets 350₁₋ₙ generated by encoder 112, where n is the number of encoded segments for each frame group. The segment reference pixel value sets 350, according to one embodiment of the present invention, may have up to four (4) reference pixel values corresponding to red 361, green 362, blue 363 and black 364 for each segment of a video frame 210. The segment reference pixels are selected based upon the video frame 210's most intense dominant pixel color values for each encoded segment, as illustrated by red 361, green 362, blue 363, and black 364. The most intense dominant pixel color value is based on the highest raw pixel color values. The black segment reference pixel 356, according to one embodiment of the present invention, may be determined by comparing the color component values (e.g., RGB) in aggregate. The segment reference pixel values may also include pixel parameter values, such as luminance value 356₁ and chrominance value 357₁ for each of the segment reference pixel colors 361-364. In other embodiments, the segment reference pixel values may also be scaled or alternatively, the reference pixel values may be full-scale values corresponding to the raw data format. In alternate embodiments, additional reference values may be used for color depth or other similar graphics data or pixel parameters. Calculation of the pixel reference value sets 350 will be discussed in greater detail below.

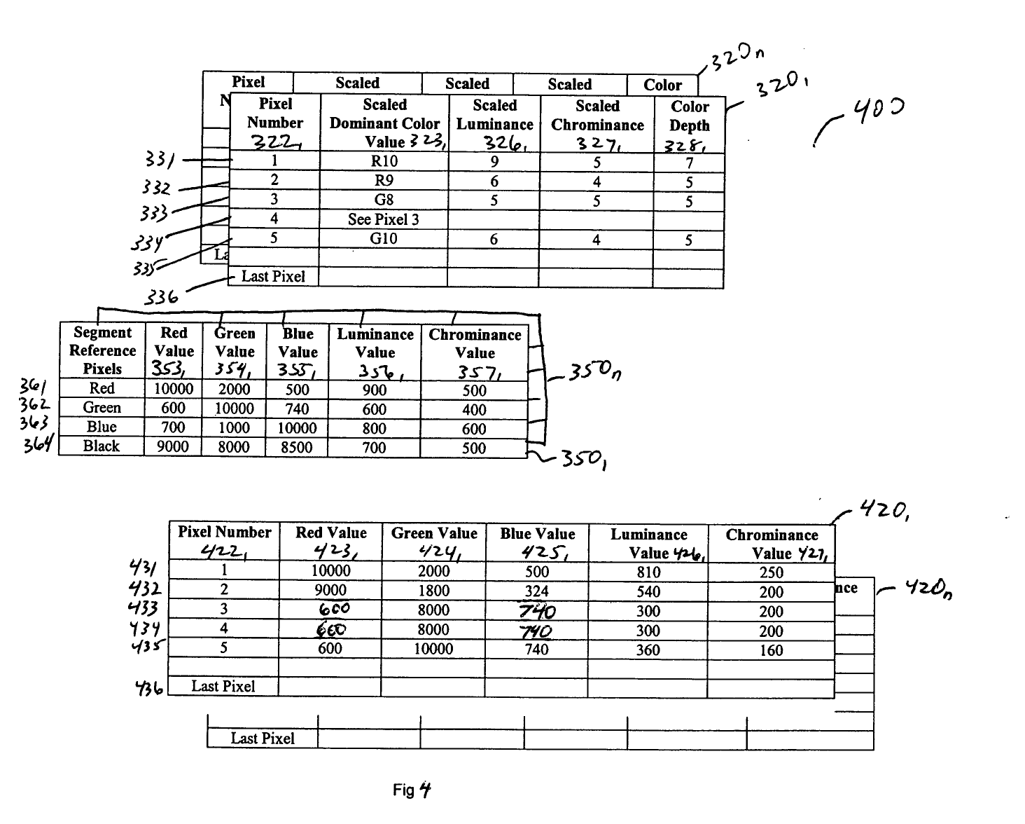

FIG. 4 illustrates an exemplary decoding process 400 for a compressed video file 114, according to one embodiment of the present invention. Compressed video file 114 may include a frame group header, segment reference pixel values 350, and encoded video tables 320 for each video frame 210. Decoder 118 processes compressed video file 114 to provide a decoded video file 120. Decoded video file 120 includes a decoded video table 420 including decoded pixel parameter values 422-427 for each pixel 431-436. Decoding process 400 includes the mapping of a compressed video table 320 to a decoded video table 420 using segment reference pixel values 350. The pixel data 331-336 is decoded using table 350 and is respectively mapped to pixel data 431-436. The process performed by decoder 118 to populate decoded video table 420 will be described in detail below.

The decoded video file 120 can be formatted for playback devices supporting different input protocols. Such protocols include NTSC, SECAM, PAL and HDTV as described above. Additionally, support for computer displays is provided. If a low-bandwidth communication link exists between display 122 and decoder 118, decoder 118 may be configured, in one embodiment, to transmit a fraction of the lines per frame. In another embodiment, in order to minimize bandwidth consumption, the encoder 112 may encode only a fraction of the lines per frame, such as one of two fields of video, resulting in a smaller compressed video file 114 for transmission over network 116. In other embodiments, the video frames may be encoded in their entirety but a field is removed and/or the screen resolution is reduced prior to transmission over network 116. In yet another embodiment, frames may be dropped prior to transmission. For example, a file encoded at 24 frames per second may be reduced to 12 frames per second by dropping ever other frame prior to transmission. These embodiments may be particularly useful when the playback device 122 is a cellular telephone or other wireless device, requiring high quality video over low bandwidth networks, such as GSM, CDMA, and TDMA.

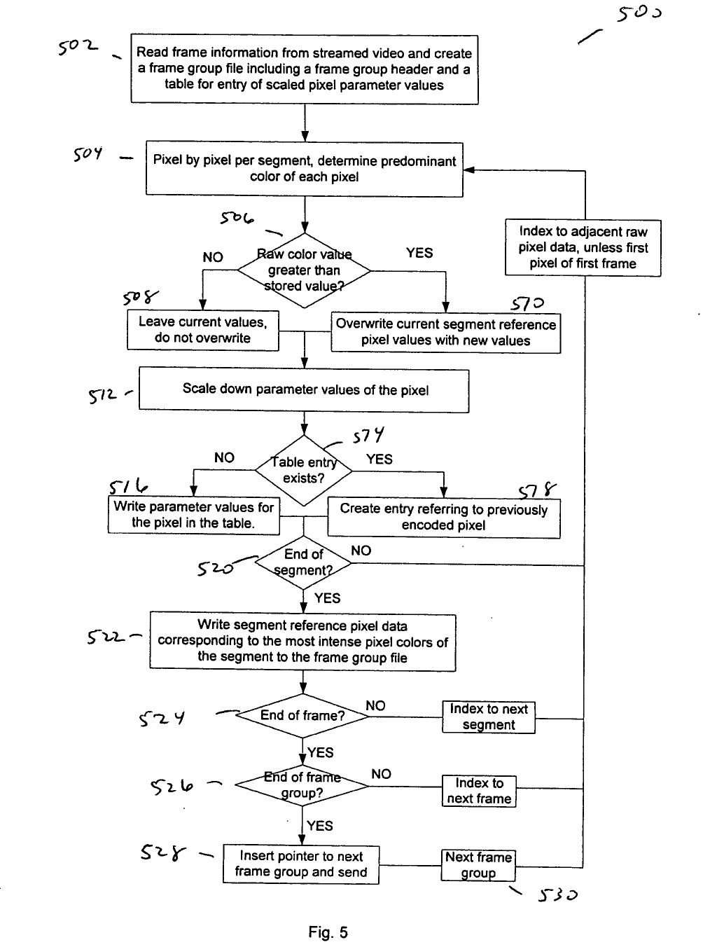

FIG. 5 illustrates a flowchart of encoding process 500 for encoding live or streaming video content, according to one embodiment of the present invention. As discussed with reference to FIG. 1, encoder 112 receives raw video data 106 for encoding. The encoder 112 then provides a compressed video file 114, including frame group header, segment reference pixel values 350, frame group table 320, and any additional parameters and optional information described above, to a decoder 118 via network 116.

In one embodiment of the present invention, the encoder 112 receives the digitized video data as raw video data 106. At block 502, the encoder 112 determines from the raw video data 106 the video format and frame information, and creates a frame group file in which a frame group header, a table of scaled pixel parameter values, and reference pixels will be stored. In another embodiment, the audio is also stored in the frame group file. The raw video data 106 may be of any format known in the art such as MPEG (Moving Picture Experts Group), MJPEG (moving JPEG (Joint Photographic Experts Group)), QuickTime's AVI (audio video interleaved), among others.

For example, with reference to FIG. 2, the encoder 112 receives raw pixel data for frames 210 as further illustrated in the raw pixel data tables 220. At block 504, the encoder 112 determines, pixel by pixel and per segment, the dominant color of each pixel by examining each pixels color component values. For example, pixel one data 231 includes a red color component value 223₁ of 10,000, a green component value 224₁ of 2,000, and a blue component value 225₁ of 500. Therefore, in one embodiment pixel 1's dominant color value would correspond to the highest numerical value among the three color values (RGB) which is the red value of 10,000. In other embodiments other techniques for calculating the dominant color may be used, such as weighted color component value comparisons. At block 506, the current pixel's color component values are compared to the highest previously stored values for that color component in order to determine the segment reference pixels corresponding to the most intense pixels for each color for each segment. In the case of a black pixel or segment reference pixel, according to one embodiment of the present invention, the color component values would all have to be above a threshold value. For example, black segment reference pixel 364 has red, green and blue values of 9000, 8000, and 8500, respectively. Although the values may not be the highest value for each color (e.g., red segment reference pixel 361 red value of 10000), the black segment reference pixel corresponding to the most intense black pixel of the segment, is the pixel with the highest of all three color component values, red, green and blue. If any one of the values is below a threshold value, the higher of the remaining two values determines the color pixel. An exemplary threshold value may be eighty percent of the maximum color component value for each color (e.g., 80% of 10000=8000). In another embodiment, a white segment reference pixel and white dominant pixel table values are based upon the color component values being below a threshold value. Continuing at block 508, if the current color component value(s) is (are) not greater than the stored segment reference pixel value(s), the stored values remain unchanged. However, if the current color component value(s) is (are) greater than the stored value(s) then the encoder 112 overwrites the current segment reference pixel values corresponding to that color component with the new values.

A segment may be defined as any portion of a frame or frames. For example, with reference to FIG. 2, a segment may be defined as the first line of a frame as shown in 210₁ pixels 1 to 5. Among various embodiments, a segment may be multiple frames, two lines of a frame or half of a frame. It should be appreciated that the segment size definition may be optimized to accommodate a variety of systems to minimize encoder processor overhead and maximize the frame transfer rate for streaming video content over a low-bandwidth connections.

An example illustrating the concept of storing the segment reference pixel values is shown with reference to FIGS. 3A and 3B, respectively. As shown in table 220₁ of FIG. 3A, pixel parameters 231 and 232 each indicate that the dominant color for each pixel is red based upon a comparison of their respective RGB values. However, the red value for pixel one of 10,000 is greater than that of pixel two 9,000 and therefore would remain as the red segment reference pixel as shown in table 350 of FIG. 3B. The segment reference pixel also retains its other pixel parameters such as green color component value 354₁, blue color component value 355₁, luminance value 356₁, and chrominance value 357₁. In other embodiments, all or some of these values may be scaled or otherwise manipulated to decrease table size or alter display characteristics.

After the dominant color of each pixel is determined and the color component values are compared to the stored segment reference pixel values, the pixel parameters, at block 512, are scaled down and stored in the table. In one embodiment, as illustrated with reference to FIG. 3A table 320₁, the scaled pixel values include scaled predominant color value 323₁, scaled luminance value 326₁, scaled chrominance value 327₁, and a calculated color depth value 328₁. In one embodiment of the present invention, only the dominant color value, luminance value, and chrominance value are scaled down and stored in the table. In another embodiment, all of the raw pixel parameter values are scaled down and stored within the table, including the non-dominant color values.

In one embodiment of the present invention, as shown in FIG. 3A, the pixel parameters 231-235 are scaled down into a one through ten (1-10) scale as shown with scaled pixel parameters 331-335 of table 320₁. For example, pixel parameter row 233 of table 220₁ indicates the dominant pixel color is green with a green color component value of 8,000 and a luminance and chrominance value of 490 and 510, respectively. If full-scale raw color values were 10,000, then the dominant color value may be rounded to the nearest thousand and divided by the full scale to produce a 1-10 value. For example:
Green dominant raw (Gd) value of 8000 (note, a value 8200 would round to 8000);

$$\frac{Scaled Value ( Gd )}{10} = \frac{8000}{10000} ; Scaled Gd = G8$$

As shown in scaled pixel parameter row 333 of table 320₁, wherein a dominant green color value of 8,000 becomes G8. Similarly, if the luminance and chrominance have full-scale values of 1,000, those values for pixel parameter row 233 would each become 5, respectively. For example:
Luminance (Lm) value of 490 rounds up to 500;

$$\frac{Scaled Lm}{10} = \frac{500}{1000} ; Scaled Lm = 5$$

$$( Similar calculation for chrominance )$$

In one embodiment, the color depth is calculated based upon the average of the scaled down luminance and chrominance values and as illustrated in table 320₁. In another embodiment, the calculation is performed at the decoder. In yet other embodiments, the raw values may be scaled into any number of ranges, such as a 1-25 scale.

Once the pixel parameters are scaled down and prior to storing the parameters in the table, the encoder 112, checks the current pixel parameter values with previously stored values in the table. If the scaled down parameter values are unique, at block 516, encoder 112 writes the parameter values for the pixel into the table. However, if an identical or sufficiently similar (e.g., within a tolerance amount) table entry already exists, the encoder 112, at block 518, creates an entry for the current pixel that refers to the previously encoded pixel in the table. For example, with reference to FIG. 3A, pixel parameter row 234, if scaled according to the process described above, would have identical scaled dominant pixel color, luminance, and chrominance to that of pixel parameter row 233. Therefore, encoder 112 inserts a reference to the previously encoded pixel as shown with reference to table 320, row 334. It should be appreciated that in dealing with tens of thousands of pixels, the combination of scaling down the dominant color, luminance, and chrominance values in addition to inserting pointers for redundant pixel values will result in a significant reduction in the size of the encoded pixel table over that of the raw pixel table, and thus the amount of bandwidth required to transmit this information to a decoder is reduced.

The encoder 112, at block 520, checks whether or not the encoding has reached the end of the segment. If the end of the segment has not been reached, then encoder 112 indexes to the next pixel corresponding to the next pixel parameter row and repeats blocks 506 through 518.

At the end of each segment, at block 522, the encoder 112 retrieves the segment reference pixel values corresponding to the most intense dominant pixel colors for the segment and writes those segment reference pixels to the frame group file. In one embodiment of the present invention, the coordinates assigned to a segment reference pixel are the coordinates of the pixel prior to a pixel color change within the segment, or if there is not a color change leading up to the end of the segment, the segment reference pixel coordinates for that color are the coordinates of the last pixel of the segment. In other embodiments, the segment reference pixels may be stored, by coordinate references or otherwise, according to any programming method that would allow for the values to be scaled according to the encoding method described above.

If a segment only has fewer than four reference pixel colors represented therein, then there may be fewer than few segment reference pixels associated with that segment. For example, if a segment includes a row of five pixels, as illustrated with reference to FIGS. 2 and 3, table 320 illustrates that the segment only includes dominant color values of red and green and therefore will only have a red and green segment reference pixels as further illustrated in FIG. 3B, segment reference pixel data 361 and 362. Therefore, in this example, the encoder 112 would only write segment reference pixel data corresponding to the most intense red and green pixel colors of the segment to the frame group file.

Once the encoder 112 writes the segment reference pixel data to the frame group file, the encoder 112, at block 524, determines if it has reached the end of the frame in the encoding process. If the process has not reached the end of the frame, the encoder 112 indexes to the next segment and repeats blocks 504 through 520. If another frame has been reached, at block 526, the encoder 112 determines whether it has encoded the entire frame group. If the entire frame group has not been encoded, the encoder 112 indexes to the next frame and repeats blocks 504 through 524. However, if the end of the frame group has been reached, the encoder 112, at block 528, inserts a pointer used by the decoder 118 to identify the next frame group for decoding. Thereafter, the encoder 112 communicates the frame group in the compressed video file 114 through the network 116 to the decoder 118. At block 530, the encoder 112 begins encoding the next frame group and repeats blocks 404 through 528. In one embodiment, the frame group file includes multiple tables comprised of multiple frames. For example, a table may include pixel information for 25 frames and a frame group may include five tables thus equaling 125 frames per frame group.

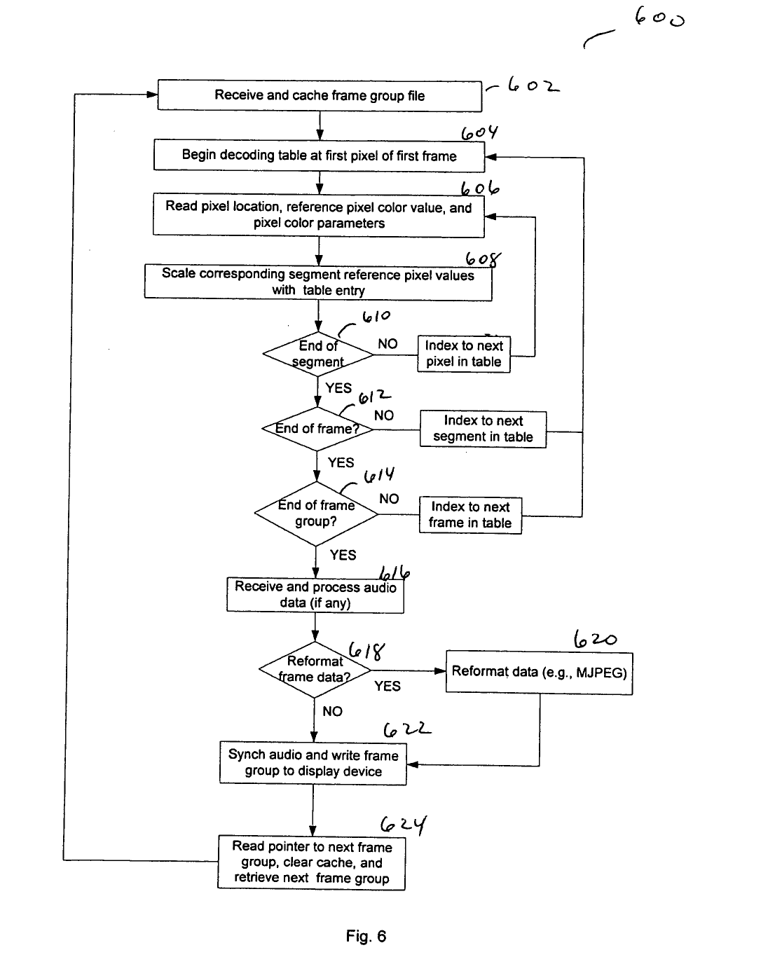

FIG. 6 illustrates a flowchart of a decoding process 600, according to one embodiment of the present invention. As discussed with reference to FIG. 1, decoder 118 receives the compressed video file 114 through network 116. After decoding, the decoder 118 supplies decoded video data 120 to playback device 122.

The decoding process 600 begins at block 602 by receiving and caching (temporarily storing) the compressed video file 114 from network 116. At block 604, the decoder 118 begins decoding the scaled table of pixel parameter values beginning at the first pixel of the first frame. The decoder 118 reads from the table, the pixel location, reference pixel color value, luminance and chrominance. At block 608, the decoder 118 scales the corresponding segment reference pixel values according to the table of pixel parameter values.

For example, with reference to FIG. 4, the decoder 118 uses the encoded pixel parameter values of table 320₁ and the segment reference pixels of table 350₁ to generate decoded pixel parameter values as illustrated in table 420₁. For example, using the scaled dominant color value G8 of pixel three, the scaled luminance and chrominance of 5, and the green segment reference pixel 362 results in decoded pixel three values of table 420₁.

For example:
Pixel parameter values of G8 (G, use green segment reference pixel), luminance (Lm) 5, and chrominance (Cm) 5, from table 350₁:
Segment Reference Pixel G—R600, G10000, B740, Lm600, Cm400.
Non-dominant R and B remain the same, scale dominant G Lm and Cm:

$$\frac{8}{10} = \frac{Scaled G ( Gs )}{10000} ; Gs = 8000 ; Rs = 480 ; Bs = 592$$

$$\frac{5}{10} = \frac{Scaled Lm}{600} ; Lm = 300 ; \frac{5}{10} = \frac{Scaled Cm}{400} ; Cm = 200$$

Therefore, the decoded table entry would appear as illustrated in 433 of table 420 and is duplicated below:
Decoded Pixel 3—R600, G8000, B740, Lm300, Cm200;

In another embodiment, R and B are scaled by the same factor of 0.8, similar to the calculation for Gs, above. In another embodiment, however, the scaled values of the table may include the non-dominant colors that may also be decoded with reference to the segment reference pixels. In other embodiments, the segment reference pixel values are the original raw full-scale values, and are either communicated with the table of scaled values or are resident within the decoder system.

In the case where an entry in the table of scaled pixel values is a reference pointer to a previous pixel entry, the decoder 118 duplicates the decoded results of previous pixel entry.

The decoder 118 indexes to the next pixel to decode in the segment if it is determined, at block 610, that the segment has not been fully decoded. If the end of the segment has been reached, the decoder 118 determines at block 612 if the end of the frame has been reached. If not, then the decoder 118 begins decoding the next segment of the frame using the process described above. If the entire frame has been decoded, the decoder determines, at block 614, if the entire frame group has been decoded. If not, the decoder 118 begins decoding the next frame in the table. If the entire frame group has been decoded, the encoder 118, at block 616, receives and decompresses (if necessary) any audio data associated with the previously decoded frame group. At block 618, the decoder determines if the frame data requires reformatting for display. In one embodiment of the present invention, the user of the display device configures the decoder to format the decompressed video data 120 to accommodate various playback devices, such as Microsoft's Windows Media Player. If reformatting is required, reformatting is executed at block 620 and decoder, at block 620 synchronizes the audio and writes the decoded frame group to the playback device 122.

After decoding and displaying the decoded frame group, according to one embodiment of the present invention, the decoder 118 at block 624, reads from the frame group the pointer to the next frame group for decoding, and clears the previously decoded frame group from the cache. In one embodiment, the decoder may read a trailer appended to the communicated file. The trailer may provide the decoder with audio/video information, such as the logical location or name of the next frame group to decode, the number of frames and or files remaining in the encoded video, index information to the next file, or other audio/video information related to playback.

Having discussed numerous illustrations of encoding and decoding functions according to the present method and system, a brief description of the communication network and computer architecture encompassing the present system is provided.

An Exemplary Network Architecture

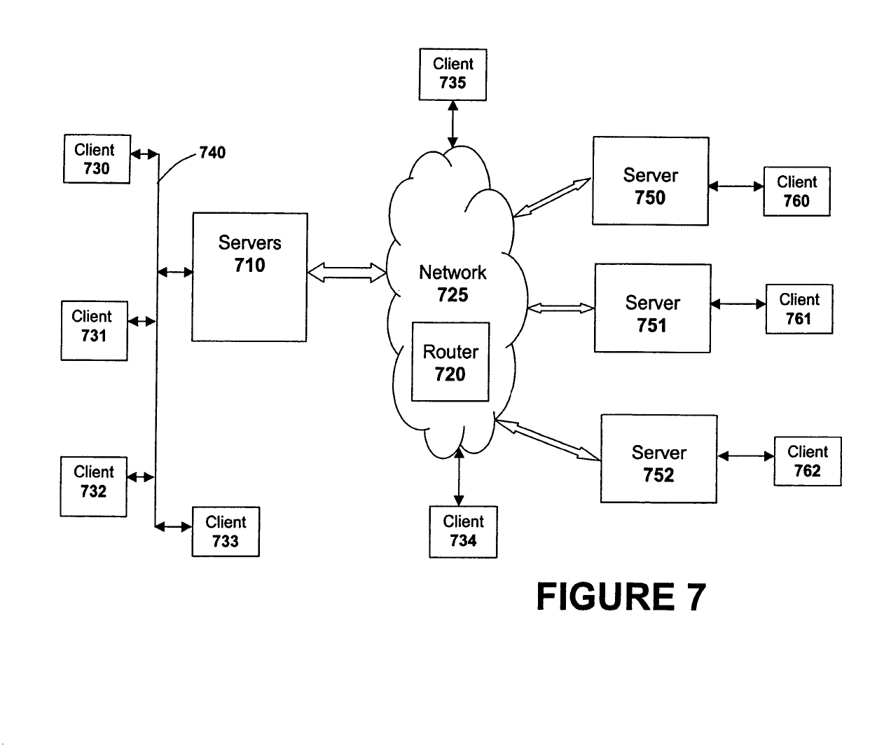

Elements of the present invention may be included within a client-server based system 500 such as that illustrated in FIG. 7. One or more servers 710 communicate with a plurality of clients 730-735. The clients 730-735 may transmit and receive data from servers 710 over a variety of communication media including (but not limited to) a local area network 740 and/or a larger network 725 (e.g., the Internet). Alternative communication channels such as wireless communication via GSM, TDMA, CDMA, Bluetooth, IEEE 802.11, or satellite broadcast (not shown) are also contemplated within the scope of the present invention.

Servers 710 may include a database for storing various types of data. This may include, for example, specific client data (e.g., client account information and client preferences) and/or more general data. The database on servers 710 in one embodiment runs an instance of a Relational Database Management System (RDBMS), such as Microsoft™ SQL-Server, Oracle™ or the like. A user/client may interact with and receive feedback from servers 710 using various different communication devices and/or protocols. According to one embodiment, a user connects to servers 710 via client software. The client software may include a browser application such as Netscape Navigator™ or Microsoft Internet Explorer™ on the user's personal computer, which communicates to servers 710 via the Hypertext Transfer Protocol (hereinafter “HTTP”). Among other embodiments, software such as Microsoft's Word, Power Point, or other applications for composing and presentations may be configured as client decoder/player. In other embodiments included within the scope of the invention, clients may communicate with servers 710 via cellular phones and pagers (e.g., in which the necessary transaction software is electronic in a microchip), handheld computing devices, and/or touch-tone telephones.

Servers 710 may also communicate over a larger network (e.g., network 725) to other servers 750-752. This may include, for example, servers maintained by businesses to host their Web sites—e.g., content servers such as “yahoo.com.” Network 725 may include router 720. Router 720 forwards data packets from one local area network (LAN) or wide area network (WAN) to another. Based on routing tables and routing protocols, router 720 reads the network address in each IP packet and makes a decision on how to send if based on the most expedient route. Router 720 works at layer 3 in the protocol stack.

According to one embodiment of the present method and system, components illustrated in FIG. 1 may be distributed throughout network 700. For example, video sources may be connected to any client 730-735 or 760-762, or sever 710 or 750-752. Live feed source 104, encoder 112, decoder 118 and display 122, may reside in any client or server, as well. Similarly, all or some of the components of FIG. 1, may be fully contained within a signal server, or client.

In one embodiment, servers 750-752 host video acquisition device 104 and encoder 112. Video sources connected to clients 760-762 provide source video to servers 750-752. Servers 750-752 encode and compress the live source video and deliver the compressed video file 114 upon a client request. Upon client 730-732 request, servers 750-752 transmit the compressed video file 114 over network 116 to the client 730-733 via server 710. In addition, server 710 and the client 730-733 may be connected via a dial-up connection between 9.6 kbps and 56 kBps. Clients 730-733 hosts decoder 118, and upon receiving the compressed video file 114, decodes the file 114 and provides the decoded video file 120 to an attached playback device. Numerous combinations may exist for placement of encoder 112, decoder 118 and video acquisition device 104. Similarly, encoder 112, decoder 118 and live feed source 104 may exist in software executed by a general purpose processor, a dedicated video processor provided on an add-on card to a personal computer, a PCMCIA card, an ASIC (application specific integrated circuit) or similar devices. Additionally, decoder 118 may reside as a software program running independently, or as a plug-in to a web browser. Decoder 118 may be configured to format its video output to have compatibility with existing playback devices that support motion JPEG, MPEG, MPEG-2, MPEG-4 and JVT standards.

An Exemplary Computer Architecture

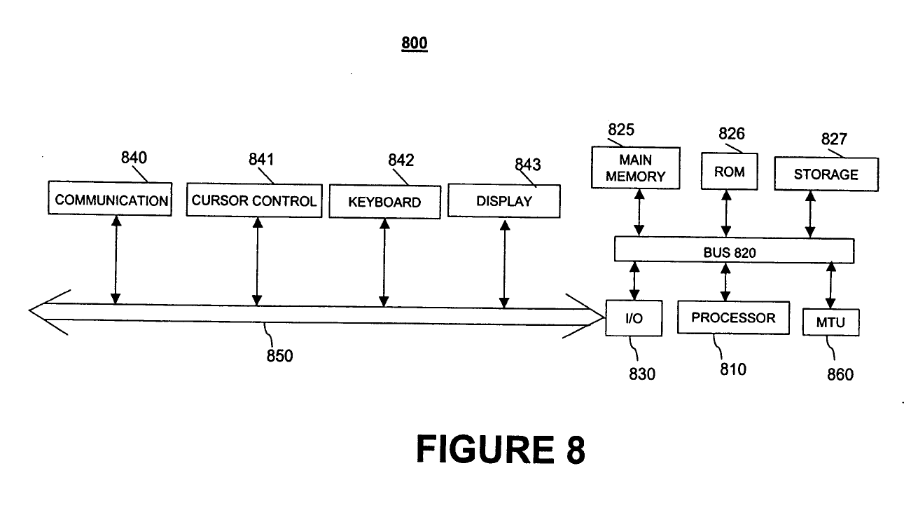

Having briefly described an exemplary network architecture which employs various elements of the present invention, a computer system 600 representing exemplary clients 730-735 and/or servers (e.g., servers 710), in which elements of the present invention may be implemented will now be described with reference to FIG. 8.

One embodiment of computer system 800 comprises a system bus 820 for communicating information, and a processor 810 coupled to bus 820 for processing information. Computer system 800 further comprises a random access memory (RAM) or other dynamic storage device 825 (referred to herein as main memory), coupled to bus 820 for storing information and instructions to be executed by processor 810. Main memory 825 also may be used for storing temporary variables or other intermediate information during execution of instructions by processor 810. Computer system 800 also may include a read only memory (ROM) and/or other static storage device 826 coupled to bus 820 for storing static information and instructions used by processor 810.

A data storage device 827 such as a magnetic disk or optical disc and its corresponding drive may also be coupled to computer system 800 for storing information and instructions. Computer system 800 can also be coupled to a second I/O bus 850 via an I/O interface 830. Multiple I/O devices may be coupled to I/O bus 850, including a display device 843, an input device (e.g., an alphanumeric input device 842 and/or a cursor control device 841). For example, video news clips and related information may be presented to the user on the display device 843.

The communication device 840 is for accessing other computers (servers or clients) via a network 725, 740. The communication device 840 may comprise a modem, a network interface card, or other well-known interface device, such as those used for coupling to Ethernet, token ring, or other types of networks.

In the foregoing specification, the invention has been described with reference to specific embodiments. It will, however, be evident that various modifications and changes can be made without departing from the broader spirit and scope of the invention as set forth in the appended claims. The specification and drawings are, accordingly, to be regarded in an illustrative rather than a restrictive sense.

1. A method, comprising:
encoding a frame of audio/video data, segment by segment, comprising a number of pixels each having a plurality of pixel color components by:
creating a frame group table of encoded pixel values in which each pixel entry includes a dominant pixel color component of the plurality of pixel color components; and
determining a set of segment reference pixels for each encoded segment, wherein each one of the segment reference pixels is a pixel within each one of the encoded segments having a most intense dominant pixel color value.

2. The method of claim 1, wherein each pixel entry further includes at least one pixel parameter value.

3. The method of claim 2, wherein the pixel parameter values include at least one of luminance, chrominance, and color depth information.

4. The method of claim 2, including scaling down each pixel parameter value prior to storing each pixel entry into the frame group table.

5. The method of claim 1, wherein prior to encoding the frame of audio/video data, creating a frame group file to store a header, the frame group table, and each set of segment reference pixels.

6. The method of claim 5, wherein after creating the frame group table, writing a pointer to a next frame group to the frame group file.

7. The method of claim 5, including storing audio data within the frame group file.

8. The method of claim 1, including encoding audio data into the frame group table.

9. The method of claim 1, including encoding audio synchronization tags into the frame group table.

10. The method of claim 1, wherein determining the set of segment reference pixels includes comparing, on a pixel by pixel basis for each segment, a current pixel color value with a previously stored dominant pixel color value and storing the plurality of pixel color components and pixel parameters of the pixel with the most intense dominant pixel color component.

11. The method of claim 1, wherein each pixel entry further comprises scaled down non-dominant pixel color components.

12. The method of claim 1, wherein the plurality of pixel color components comprises at least one of the sets of primary color components, red, green, and blue, or cyan, magenta, and yellow.

13. The method of claim 12, wherein the dominant pixel color components include red, green, blue, and black.

14. The method of claim 13, wherein the dominant pixel color component black is determined by comparing an average of the red, green, and blue pixel component values to a black threshold value.

15. The method of claim 1, wherein an encoded segment is a row of pixels within the frame of audio/video data.

16. The method of claim 1, wherein creating a frame group table further comprises scaling down the dominant pixel color component.

17. The method of claim 1, wherein the frame group table includes pixel entries for a plurality of frames.

18. The method of claim 1, wherein redundant encoded pixel values of the frame group table share common table entries.

19. The method of claim 18, wherein redundant encoded pixel values share identical dominant pixel color components and identical pixel parameter values.

20. The method of claim 18, wherein redundant encoded pixel values share dominant pixel color components and pixel parameters values that are similar to one another within a tolerance range.

21. An encoder, comprising:
the encoder to create, pixel by pixel, a frame table of encoded segments of audio/video data, wherein each pixel is represented by a single pixel color component; and
the encoder to create a set of color scaling pixels for each encoded segment, wherein each color scaling pixel is selected based upon a pixel having a most significant color intensity value with respect to similarly colored pixels within the segment.

22. The encoder of claim 21, wherein the frame table data of encoded segments of audio/video data for each pixel includes pixel parameter values for at least one of, luminance, chrominance, and color depth.

23. The encoder of claim 22, wherein the pixel parameter values are scaled down values.

24. A machine readable medium storing a set of instructions that, when executed by a machine, cause the machine to execute a method, the method comprising:
encoding a frame of audio/video data, segment by segment, comprising a number of pixels each having a plurality of pixel color components by:
creating a frame group table in which each pixel entry comprises a dominant pixel color component of the plurality of pixel color components; and
determining a set of segment reference pixels for each encoded segment, wherein each one of the segment reference pixels is a pixel within each one of the encoded segments having a most intense dominant pixel color value.
